(19) United States
(12) Patent Application Publication
(10) Pub. No.: US 2014/0169285 A1
(43) Pub. Date: Jun. 19, 2014

(54) EXTENDING GLOBAL OPERATOR DEVICE IF TO AGGREGATED DEVICES

(71) Applicant: TELEFONAKTIEBOLAGET L M ERICSSON (PUBL), Stockholm (SE)

(72) Inventors: Mats SAGFORS, Kyrkslatt (FI); Jari ARKKO, Kauniainen (FI); Fredrik GARNEIJ, Goteborg (SE); Jan MELEN, Espoo (FI)

(73) Assignee: TELEFONAKTIEBOLAGET L M ERICSSON (PUBL), Stockholm (SE)

(21) Appl. No.: 13/724,601

(22) Filed: Dec. 21, 2012

(30) Foreign Application Priority Data
Dec. 19, 2012 (EP) PCT/EP2012/076057

(51) Int. Cl. H04W 76/02

(52) U.S. Cl. CPC H04W 76/023
USPC 370/329

(57) ABSTRACT

The disclosure relates to a method of managing aggregated devices being attached to a mobile communication network via at least one aggregating device; said aggregating device being attached directly to a radio base station of said mobile communication network.

The method comprises retrieving, information regarding at least one aggregated device attached to a respective aggregating device, storing said information in said node, such that the node comprises information about aggregated devices attached to said mobile communication network and providing, said information for managing said aggregated devices.

The disclosure also relates to a network node, an aggregating device and an aggregated device.

### TECHNICAL FIELD

The present disclosure relates to the field of cellular communication networks and in particular to a method of managing aggregated devices being attached to a mobile communication network via at least one aggregating device, also referred to as capillary device, wherein the aggregating device is directly attached to a radio base station of said mobile communication network. The disclosure also relates to a network node, an aggregating device and an aggregated device.

### BACKGROUND

Cellular networks are often aggregated by other network technologies in order to enable the cellular nodes to reach or be reachable beyond the boundaries of the cell itself. Typically a device in the cellular network takes on the role of a gateway or aggregating device, where traffic to and from the cellular networks passes.

One example is a mobile phone and a scale comprising means for sending data to e.g. a server on the internet. The scale typically comprises short range communication means e.g. a Wireless Local Area Network, WLAN, circuit. The scale may be attached to the internet via a mobile phone attached to a cellular network, independently of whether the scale has cellular communication means or not, e.g. by using tethering.

Another example is a system with lamp posts, wherein the first lamp post is connected to a mobile communication network with cellular connection means and the other lamp posts are connected to the mobile network via the first lamp post acting as an aggregating or capillary device. Such a setup enables lamp posts that are actually out of reach of the cellular network to be attached to the network. Another example is a system of parking meters working according to the same principle.

In mobile communication systems of today, when an aggregating device is part of a mobile operator network, the aggregating device and all devices aggregating under it, are managed as one single entity by the mobile operator support system, OSS, and business support systems, BSS, providing both systems and business solutions for the subscriber. This means that the mobile network may not support and manage a particular device. When being attached to e.g. a remote server over IP, the end point will of course know the IP address of an attached aggregated device. However, the mobile communication network will handle the aggregating device and all devices aggregated thereunder as one device.

Hence, one problem with current solutions is that all devices, in this application referred to as aggregated devices, attached under an aggregating device may not be accessed or supported from the mobile communication network on a device basis. This further implies that all aggregated devices will be treated the same in terms of priority, resources etc, even though the devices may have different requirements.

### SUMMARY

The disclosure provides for a method to associate a global identity to an aggregated device making it possible to manage the device as a unique subscriber or subscription using existing operator methods. One aspect of the disclosure comprises associating a device with an address or a sub-ID of the aggregating device and thereby being able to provide methods to service and manage the aggregated device through the aggregating device as would it be directly attached to the operator network.

The present disclosure is defined by the appended independent claims. Various advantageous embodiments of the disclosure are set forth by the appended dependent claims as well as by the following description and the accompanying drawings.

With the above and following description in mind, an aspect of certain embodiments of the present disclosure is to provide a method of managing devices being attached to a mobile communication network in which the above-mentioned drawbacks have been overcome.

Hence, the disclosure relates to a method of managing aggregated devices being attached to a mobile communication network via at least one aggregating device wherein the aggregating device is directly attached to a radio base station of said mobile communication network. The method involves retrieving, in a node of the mobile communication network, information regarding at least one aggregated device attached to a respective aggregating device, storing the retrieved information in the node, such that the node comprises information about aggregated devices attached to said mobile communication network and providing in said node, said information for managing said aggregated devices. Thereby, the aggregated devices may be serviced from the mobile communication network.

According to one aspect of the disclosure, the information comprises a global device identifier uniquely identifying said aggregated device. Thereby, the aggregated devices are identified in the mobile communication network.

According to one aspect of the disclosure, the information comprises an address of an aggregated device. Thereby the aggregated devices may be addressed by the mobile communication network e.g. for wake up or paging.

According to one aspect of the disclosure, the aggregating device has a subscription to said mobile communication network and said information associates the aggregated device with said subscription.

According to one aspect of the disclosure, it further comprises generating a list of information of said aggregated devices in said node.

According to one aspect of the disclosure, it further comprises providing an interface in said node for accessing said information.

According to one aspect of the disclosure, it further comprises providing methods to service and manage the aggregated device through the aggregating device as would it be directly attached to the operator network.

According to one aspect of the disclosure, it further comprises a node in a mobile communication network, communicating with at least one aggregated device being attached to the mobile communication network via at least one aggregating device. The aggregating device is attached directly to a radio base station of said mobile communication network.

The node comprises a network communication unit configured to communicate with said mobile communication network and a memory configured to store information about aggregated devices attached to said mobile communication network. It further comprises a processor configured to retrieve, using the network communication unit, information regarding at least one aggregated device attached to a respective aggregating device and storing said information in said memory, such that the node comprises information about aggregated devices attached to said mobile communication network. The processor is further configured to provide the information for managing the devices.

According to one aspect of the disclosure, it relates to an aggregating device configured for attaching at least one aggregated device to a mobile communication network. The aggregating device comprising a network communication unit configured to communicate with said mobile communication network and a processor configured to send, using said network communication unit, information regarding at least one aggregated device being attached to the aggregating device, wherein the retrieved information uniquely identifies each aggregated device.

According to one aspect of the disclosure, it relates to an aggregated device, configured for being attached to a mobile communication network via an aggregating device. The aggregated device comprises a network communication unit configured to communicate with an aggregating device and a processor configured to send, using said network communication unit, information uniquely identifying the aggregated device.

With the above description in mind, the object of the present disclosure is to overcome at least some of the disadvantages of known technology as described previously.

### BRIEF DESCRIPTION OF THE DRAWINGS

Further objects and features, of the present disclosure will appear from the following detailed description of some embodiments/aspects of the disclosure, wherein some aspects of the disclosure will be described in more detail with reference to the accompanying drawings, in which:

FIG. 1 schematically illustrates a mobile communication network with aggregating devices;

FIG. 2 is a flowchart illustrating the method steps for managing aggregated devices;

FIG. 3 schematically illustrates providing, A, information for managing, B, aggregated devices in a mobile communication network;

FIG. 4 schematically illustrates retrieving information for managing aggregated devices from a network node;

FIG. 5 schematically illustrates retrieving information for managing aggregated devices from an aggregated and/or aggregating device;

FIG. 6 illustrates a network node;

FIG. 7 illustrates an example of an aggregating device;

FIG. 8 illustrates an example of an aggregated device;

It should be added that the following description of the embodiments is for illustration purposes only and should not be interpreted as limiting the disclosure exclusively to these embodiments/aspects.

### DETAILED DESCRIPTION

Embodiments of the present disclosure relate, in general, to the field of mobile communications and, in particularly, to a mobile communication network where aggregated devices are indirectly attached to the network via one or more aggregating device.

The term aggregating device, or capillary device, in this application refers to a device capable of being directly attached to a cellular communication network using cellular access or short range standards. Directly implies that the aggregating device may send and receive data and signalling over an air-interface to and from the radio base station.

The term “directly attached” does not imply that the aggregating device must be continuously connected with the particular radio base-station. For example, the aggregating device may perform handover to another radio base-station, in which case the device is now directly connected with another radio base station. Or, the aggregating device may temporarily release the connection to the particular radio base-station. In that case, the aggregating device is typically still attached to another node in the network, and the aggregating device can be reached with paging, where the paging message is often sent in many cells from many radio base stations. This means that the aggregating device can easily be re-connected, or attached directly, to one of the radio-base stations, even if the attachment to the radio-base station was temporarily released.

Being attached means that a device is associated with or possibly connected with a network or other device in some sense. Typically, such an attachment is achieved by an attach request or connection request by the device, followed by signalling sequences where the request is verified and accepted. In many cases, such a sequence includes authentication and establishment of a security context between the parties. The attachment does not always imply that any resources for data transmission to or from the device are reserved. Such resources are typically reserved on a need basis, but the attachment often allows for quicker reservation of such resources when the communicating parties are known to each other through the attachment.

The aggregating device is further adapted to act as a link or gateway for attaching further devices, referred to as aggregated devices, to the mobile communication network. The aggregating device may be a smartphone, a wireless modem, an M2M device or any other device fulfilling those requirements.

The term aggregated device in this application refers to a device capable of being attached to a cellular communication network via an aggregating device. The aggregated device is attachable to an aggregating device e.g. using short range standards such as WLAN, Bluetooth, Zigbee or other. The aggregated device could either be directly attached to an aggregating device or it could be attached to an aggregating device via one or more other aggregated devices. However, there is one aggregating device between the aggregated device and the mobile communication network acting as a gateway. The aggregated and aggregating devices may also be connected or attached using any future Device to Device, D-to-D, connection protocol. Such D-to-D solutions are currently under development in 3GPP.

According to one aspect of the disclosure, the aggregated device is a user device such as a tablet or a laptop which the user wishes to connect to the internet using his or her smartphone. The aggregated device may also be a M2M device such as a lamp post or a scale, which is adapted to communicate to an internet server.

According to one aspect of the disclosure the mobile operator reuses the infrastructure and subscriber concept even for the aggregated devices serviced by an aggregating device. Thereby the device density which is possible in an operator network is increased by using short range standards extensions of mobile network coverage.

However, for the sake of clarity and simplicity, most embodiments outlined in this specification are related to one aggregating device having cellular access wherein aggregated devices are attached using short range wireless communication e.g. WLAN.

Embodiments of the present disclosure will be described more fully hereinafter with reference to the accompanying drawings, in which embodiments of the disclosure are shown. This disclosure may, however, be embodied in many different forms and should not be construed as limited to the embodiments set forth herein. Rather, these embodiments are provided so that this disclosure will be thorough and complete, and will fully convey the scope of the disclosure to those skilled in the art. Like reference signs refer to like elements throughout.

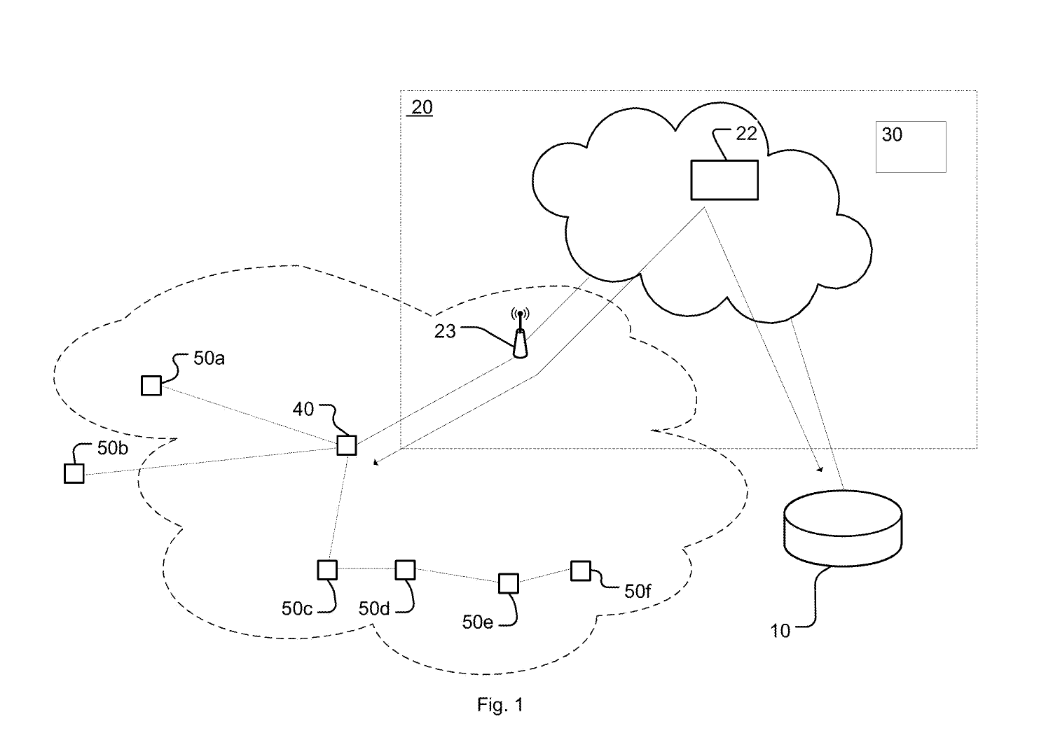

FIG. 1 schematically illustrates a mobile communication network 20, where the method of managing aggregated devices is executed. The mobile communication network 20 is any type of public network providing any services to a mobile device involving a connection and the communication of signals and data, such as a mobile access network using, e.g. GSM, UMTS, GPRS or LTE standards. For simplicity the illustration of FIG. 1 only disclose one base station 23 and one network node 22. However, it must be understood that the mobile communication network 20 also comprises a complete radio access and core network, here represented by the cloud symbol.

In FIG. 1, an aggregating device 40 is directly attached to the base station 23 of the mobile communication network 20. Six aggregated devices 50a-f are attached to the mobile communication network 20 via the aggregating device 40. Device 50c is attached directly to the aggregating device 40. Devices 50d, 50e and 50f are attached to the aggregating device 40 via other aggregated devices 50c, 50d or 50e. However, for all aggregated devices 50a-50f, the aggregating device 40 acts as a gateway to the mobile communication network 20.

A server 10 is further attached to the mobile communication network 20. The server 10 is attached to the mobile communication network either via the internet or directly. However, in the mobile communication networks of today, the aggregated devices may not be seen from the network 20. Hence, a server attached to the network questioning which devices are attached will only be informed about the aggregating device 40, because it is the only device directly attached to the network.

The mobile communication network 20 further comprises a device control platform, DCP, node 30 providing a device control service. The device control entity 30 provides access to key functionalities of devices including e.g. subscription management, device management and operator and enterprise self-service portals.

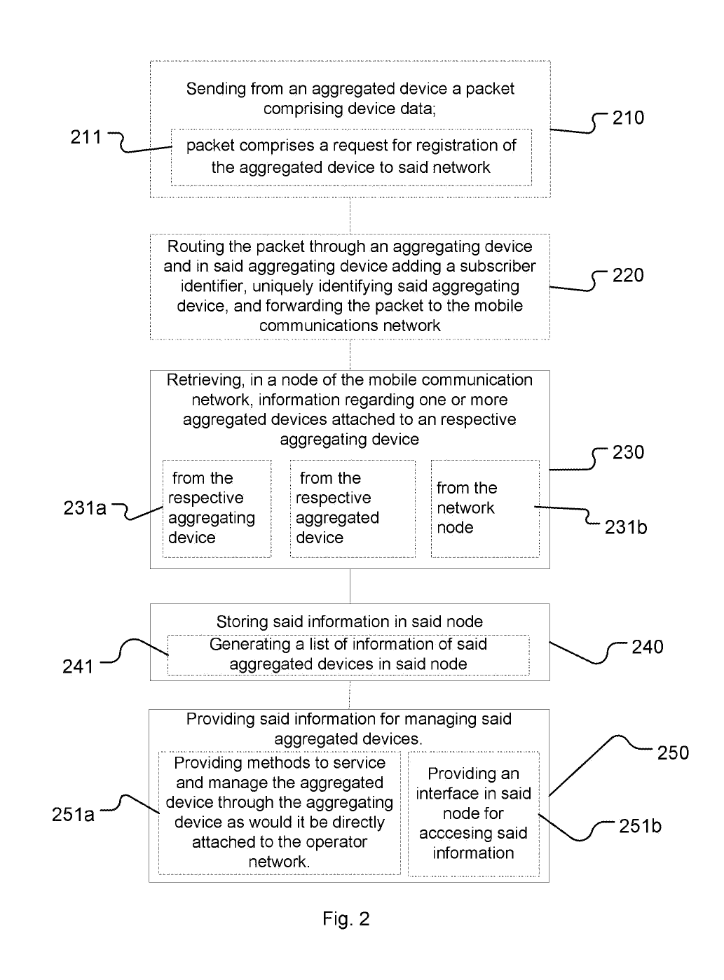

A method for managing aggregated devices 50 in a system as described in FIG. 1 will now be described. FIG. 2 is a flowchart illustrating the method of managing devices being attached to a mobile communication network 20 via at least one aggregating device 40.

In its simplest form, the method starts at step 230, wherein a node 22, 30 of the mobile communication network 20, retrieves information regarding at least one aggregated device 50, attached to an aggregating device 40. The aggregated device may be directly or indirectly attached to the aggregating device. Indirectly implies via another device. The aggregating device 40 refers to the device acting as a gateway to the aggregated device 50. One aggregating device 40 may act as a gateway for several aggregated devices 50. The information may be retrieved from different locations as will be further described below, even if the information always originates from the aggregated 50 and aggregating 40 devices. In principle this means that information regarding aggregated devices is compiled at one place, i.e. in one node 22, 30, in the mobile communication network 20.

In the next step the retrieved information is stored 240 in the node 22, 30, such that the node holds information about aggregated devices attached to said mobile communication network.

Example of nodes 22, 30 where the information is stored or compiled is a Gateway GPRS Support Node, GGSN 22, a DCP node 30 or any other node in the mobile communication network. The stored information maps information of the aggregated devices 50 to an address in the mobile communication network 20. The address specifies the location of the aggregated device in the network. The address enables the mobile communication network 20 to access the aggregated devices 50 as an individual entity. Thereby, the mobile communication network 20 holds information of aggregated devices 50 being attached to the network and knows how to access them. Hence, the mobile operator infrastructure and subscriber concept may be used even for the aggregated devices 50 serviced by an aggregating device 40.

The retrieved information regarding the aggregated devices 50 comprises e.g. a device identity or subscriber identity. According to one aspect of the disclosure it further comprises an address e.g. an IP address or an IMSI (or TIMSI). According to one aspect of the disclosure the address comprises information about the aggregating device 40 under which the aggregated device is attached. As commonly known, a mobile communication network 20 keeps track of directly attached devices authenticated in the network, e.g. in order to be able to page them if there is an incoming call. Hence, information about the aggregating device will enable the network to access the aggregated devices as well, because the aggregating device is directly attached to the mobile communication network 20.

The node could e.g. hold a global device ID and IMSI or TIMSI of the aggregating device 40 of each aggregated device 50 attached to the network. According to one aspect of the disclosure, it further comprises generating 241 a list of information of said aggregated devices in said node. The list could e.g. comprise a global device identifier and access information for aggregated devices attached to the network.

In step 250 the information is provided in the node, wherein it can be used for managing devices by e.g. a user. There are many ways of providing the information. According to one aspect of the disclosure, it further comprises providing 251b an interface in said node for accessing said information. According to one aspect of the disclosure the node comprises an interface, where an external server or mobile entity may connect and read the information. One example of such an interface is an IP interface. The information may also be provided internally within the mobile communication network e.g. in order to prioritise or watch a particular device.

According to another aspect of the disclosure, it further comprises providing 251a methods to service and manage the aggregated device 50 through the aggregating device 40 as would it be directly attached to the operator network. The network may e.g. assign different priority to different devices or send a paging message directly to an aggregated device.

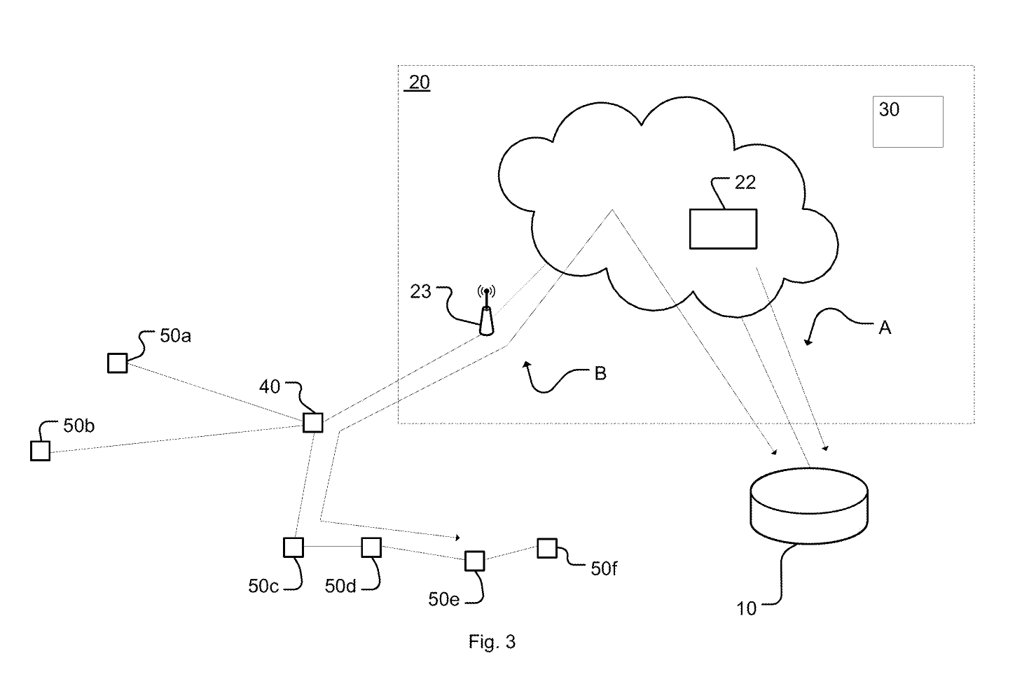

FIG. 3 schematically illustrates a network node 22 providing, A, information for managing, B, aggregated devices in the mobile communication network 20 disclosed in FIG. 1.

In FIG. 3, a server 10 fetches, illustrated by arrow A, provided information regarding aggregated devices 50 attached to the mobile communication network 20 from a network node 22. This may be initiated either from the server, by a request or by the node 22 sending the information on own initiative. As a result, the server 10 gets information of the identities of all aggregated devices 50a-50f. The network node providing information is e.g. a GGSN, a DCP node or any other network node. The information originates from the aggregated devices. However, the provided information may be retrieved from one or more network nodes of said mobile communication network 20. The information may e.g. be identity information of aggregated devices routed through a node.

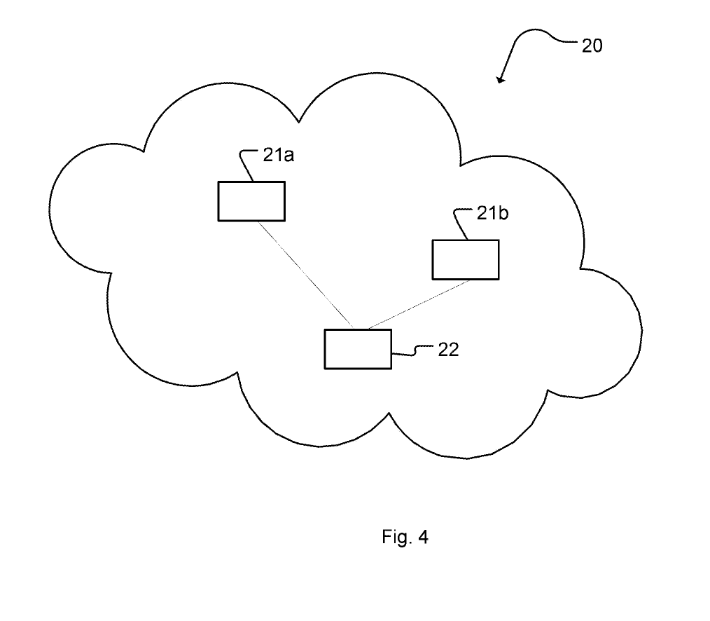

According to one aspect of the disclosure, the node 22 has retrieved the provided information about aggregated devices 50 from other network nodes in the mobile communications network e.g. GGSNs 21a, 21b holding the mapping between subscriber identities and IP addresses routed through that GGSN, as disclosed in FIG. 4. Based on that information the node 22 compiles knowledge about IP addresses used by, i.e. aggregating under, a particular subscriber. The node may then compile information describing for each subscriber, all IP addresses used by that particular subscriber.

In the next step the server 10 utilizes the retrieved information to access a particular aggregated device, illustrated by arrow B in FIG. 3. This may be done by sending a request comprising a global identity, e.g. an IP address, of the aggregated device 50 to the mobile communication network. This would not have been possible without the provided information, because then the mobile communications system 20, could not see the aggregated device 50.

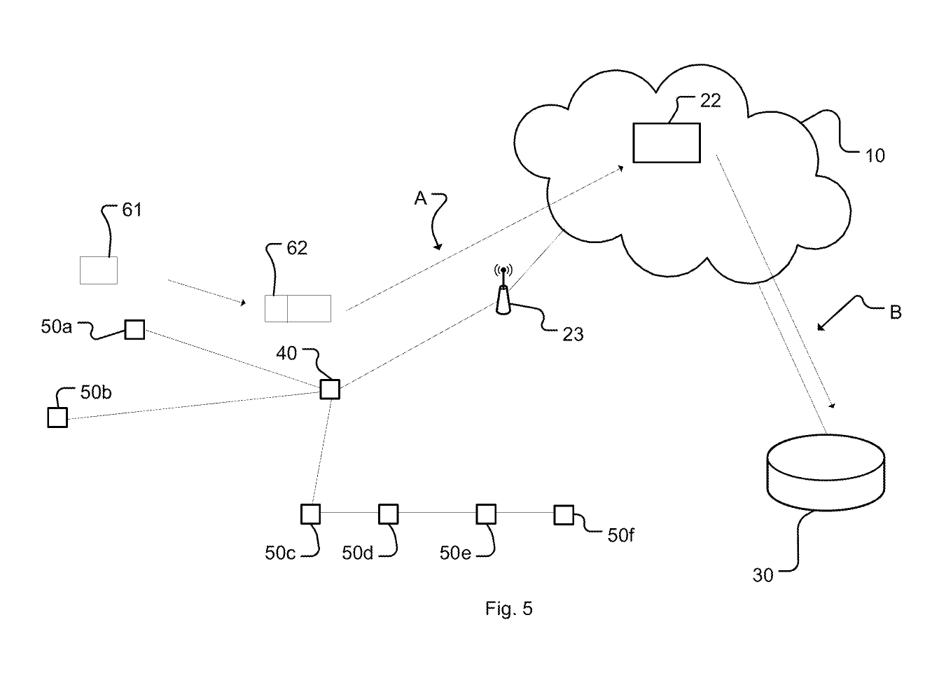

According to one aspect of the disclosure, which will now be described in connection with FIGS. 2 and 5, the network node 22 retrieves the information from the respective aggregated device 50. The information is e.g. a device identifier uniquely identifying said aggregated device. The method then starts with an aggregated device 50a sending, step 210 in FIG. 2, a packet 61 comprising device data, e.g. a device ID, to the mobile communication network 20. According to one aspect of the disclosure, the information sent from the aggregated device 50a comprises addressing information. The aggregated devices have learned that they are behind the respective aggregating device 40, and may thus include this knowledge in the information e.g. as an aggregating device identity. The method further comprises routing, 220, the packet through an aggregating device to the mobile communication network.

According to one aspect of the disclosure, the aggregating or capillary device 40, adds an identifier 62, e.g. a subscriber identifier, uniquely identifying the aggregating device 40 to the packet before forwarding it. According to another aspect of the disclosure, the aggregated device has learned under which device it is aggregated, and sends that information to the network itself.

According to one aspect of the disclosure, the packet comprises a request for registration of the aggregated device 50 in the network 211. According to another aspect of the disclosure the packet is a data packet, wherein the device data is just added as an additional header, extractable by a network node. The network node then retrieves 231b, c, information regarding at least one aggregated device 50 attached to a respective aggregating device 40, by reading the device data and the subscriber identifier, if added. Hence, in this example the node retrieves the information from the respective aggregating or aggregated device.

In the next step the retrieved information is stored 240 in the node, such that the node comprises information about aggregated devices 50 attached to the mobile communication network and in step 250 the information is provided in the node, wherein it can be used for managing devices, as already described in connection with FIG. 3.

According to one aspect of the disclosure the aggregating device 40 holds a subscription to the mobile communication network 20. A subscription is typically enabled by a SIM, which generates one or more keys that are used for encryption of data sent between the device 40 and the mobile communication network 20. According to this aspect of the disclosure the information stored in the network node associates the aggregated devices 50 with the subscription of the aggregating or capillary device 40. This information may be used in many ways. E.g. the network may register all devices of one subscriber or broadcast data to all devices of a particular subscriber. Another usage is monitoring aggregated devices 50, in order to verify that they are “alive”, at least now and then.

According to a further aspect of the disclosure, traffic, i.e. data and signaling to different aggregated devices could be prioritized differently. This is not possible in the mobile communication networks of today, since the network cannot distinguish whether the traffic is intended for the aggregating device, or any of the aggregated devices. For example, the traffic to one or a group of aggregated devices could be routed onto one radio bearer in the radio access network, and traffic to other aggregated devices or the aggregating device could be routed onto another radio bearer. Similarly, different types of traffic directed to a particular device could be given different priorities. For example signaling or real-time traffic such as voice is often given higher priority over data. In machine-type of applications, some traffic may have low priority, and could therefore be queued during congestion situation and transmitted later.

In the uplink, a similar structure for differentiating traffic may be applied, where the aggregating device uses different queues and radio bearers for queuing and for transmitting data originating from different aggregated devices. Also here, different types of traffic originating from an aggregated device could be assigned different priorities where e.g. real-time traffic such as voice is often given higher priority over data.

As is common in cellular networks, the prioritization and scheduling of the traffic both in uplink and downlink could then controlled by a node in the network, e.g. a Radio Network Controller, NodeB or evolved NodeB, using the information provided in the mobile communication networks as described above. For example, the network could schedule an aggregating device to only send data of high priority originating from one class of aggregated devices, i.e. the network could control that some of the data of low priority may not be sent from the aggregating device to the network. Thus, prioritization of traffic originating from and directed to a diverse set of aggregated devices can be achieved.

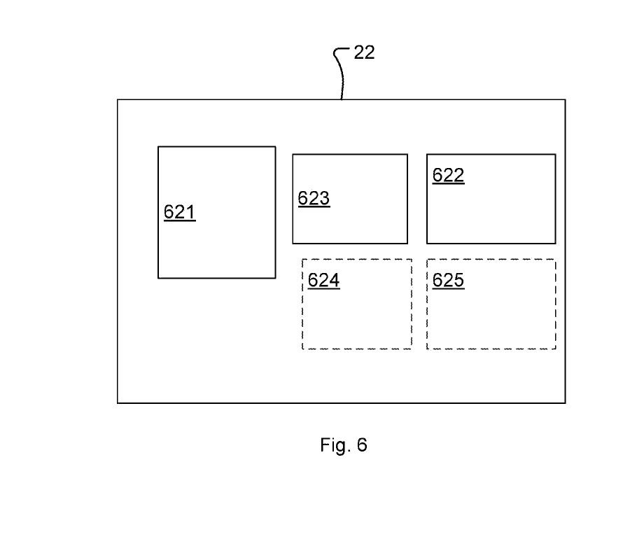

FIG. 6 discloses a network node 22 in a mobile communication network 20, communicating with at least one aggregated device 50 being attached to said mobile communication network 20 via at least one aggregating device 40. The network node is e.g. a DCP node or a GGSN. The network node comprises a network communication unit 621 configured to communicate with said mobile communication network 20, a memory 622 and a processor 623.

The memory 622 is configured to store information about aggregated devices 50 attached to said mobile communication network.

The processor 623 is configured to retrieve, using said network communication unit 221, information regarding at least one aggregated device 50 attached to a respective aggregating device 40; storing said information in said memory 622, such that the node comprises information about aggregated devices attached to the mobile communication network 20 and providing said information for managing said aggregated devices. According to further aspects of the disclosure, the processor 623 is further adapted to perform the method according to all the aspects as described above.

According to one aspect of the disclosure the node 22 is further configured to retrieve the information from the respective aggregated device 50, e.g. the aggregated device may send a request to register in the mobile communication network 20.

According to one aspect of the disclosure the node 22 further comprises a compiling means 624 for compiling a list of information of said aggregated devices 50 in said node. This list e.g. comprises a global identity of each aggregated device and information for accessing the aggregated device. The access information is e.g. information of the aggregating device or an IP address.

According to one aspect of the disclosure the node 22 further comprises an interface 625 in said node for accessing said information. According to one aspect of the disclosure the interface is external. The operator may e.g. provide an operator interface, where a subscriber may monitor its attached devices.

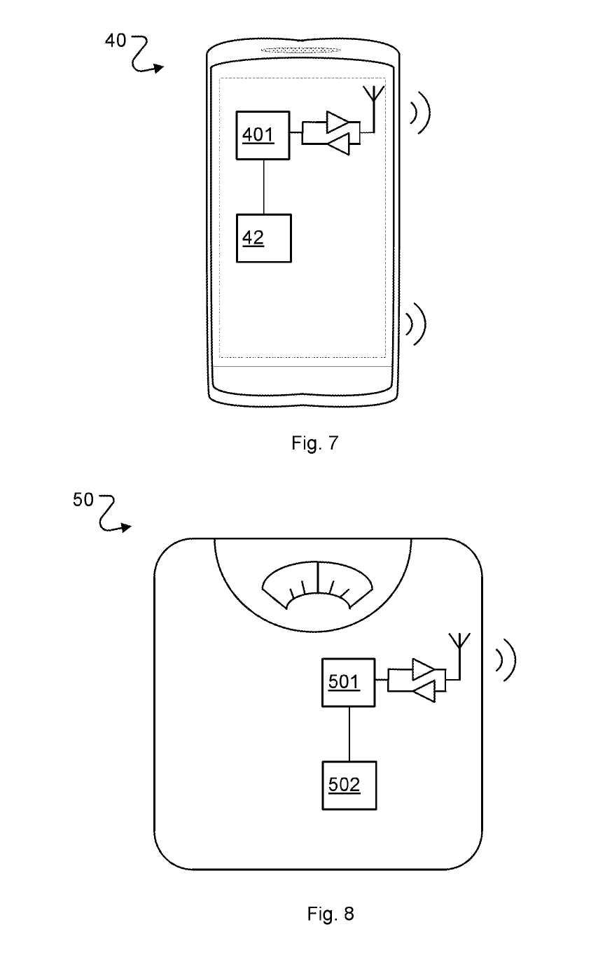

FIG. 7 discloses an aggregating device 40 in more detail.

The aggregating device 40 is configured for attaching an aggregated device 50 to a mobile communication network 20. The aggregating device 40 may be any device suitable for attaching aggregated devices 50 to the network e.g. a mobile broadband modem or a mobile phone. The aggregating device 40 comprises a network communication unit 401 and a processor 402.

The network communication unit 401 is configured to communicate with said mobile communication network 20. The network communication unit 401 is e.g. cellular communication means.

The processor 402 is configured to send, using said network communication unit 401, information regarding at least one aggregated device 50 being attached to the aggregating device 40. The information uniquely identifies each aggregated device 50 attached to the aggregating device. Information is e.g. a global device identifiers or information required for accessing the aggregated devices.

FIG. 8 discloses an aggregated device 50, configured for being attached to a mobile communication network 20 via an aggregating device 40. The aggregated device 50 comprises a network communication unit 501, here a short range circuit, and a processor 502. The aggregated device disclosed in FIG. 8 is a scale. The scale 50 registers a weight and then registers the weight at a remote server on the internet.

The network communication unit 501 is configured to communicate with an aggregating device 40. Thereby, the scale 50 gets internet access.

The processor 502 is configured to send, using said network communication unit 501, information uniquely identifying the aggregated device 50 to the mobile communication network 20. Hence, the mobile communication network knows that the scale 50 is attached to the network and also knows how to access it.

According to one aspect of the disclosure, there is no node to store the information but rather that the aggregating device 40 adds information to messages passing through it, and this information can be used end-to-end by the applications, e.g. as they ask the mobile network to do something specific. For instance, a use case would be for an application node in the Internet to send a message to the mobile communication network and ask it to wake up a particular aggregated device 50. Sometimes devices can be in deep sleep and only be woken up by an SMS.

1. A method of managing aggregated devices being attached to a mobile communication network via at least one aggregating device; said aggregating device being attached directly to a radio base station of said mobile communication network, said method comprising:
retrieving, in a node of the mobile communication network, information regarding at least one aggregated device attached to a respective aggregating device;
storing said information in said node, such that the node comprises information about aggregated devices attached to said mobile communication network; and
providing in said node, said information for managing said aggregated devices.

2. The method of managing aggregated devices attached to a mobile communication network according to claim 1, wherein said information comprises a global device identifier uniquely identifying said aggregated device.

3. The method of managing aggregated devices attached to a mobile communication network according to claim 1, wherein said information comprises an address of an aggregated device.

4. The method of managing aggregated devices attached to a mobile communication network according to claim 3, wherein said address is an IP address or an IMSI.

5. The method of managing aggregated devices attached to a mobile communication network according to claim 1, wherein the node retrieves said information from the respective aggregated device.

6. The method of managing aggregated devices attached to a mobile communication network according to claim 1, wherein the node retrieves said information from the respective aggregated device, having learned under which aggregating device it is attached.

7. The method of managing aggregated devices attached to a mobile communication network according to claim 1, wherein said aggregating device has a subscription to said mobile communication network and said information associates the aggregated device with said subscription.

8. The method of managing aggregated devices attached to a mobile communication network according to claim 1, wherein the node retrieves said information from a network node of said mobile communication network.

9. The method of managing aggregated devices attached to a mobile communication network according to claim 8, wherein said retrieved information is data of aggregated devices routed through that node.

10. The method of managing aggregated devices attached to a mobile communication network according to claim 9, wherein the network node is a Serving GPRS Support Node.

11. The method of managing aggregated devices attached to a mobile communication network according to claim 1, further comprising
sending from an aggregated device a packet comprising device data; wherein said retrieved information comprises said device data.

12. The method of managing aggregated devices attached to a mobile communication network according to claim 11, further comprising:
routing the packet through an aggregating device and in said aggregating device:
adding a subscriber identifier, uniquely identifying said aggregating device, and
forwarding the packet to the mobile communication network.

13. The method of managing aggregated devices attached to a mobile communication network according to claim 11, wherein the packet comprises a request for registration of the aggregated device to said network.

14. The method of managing aggregated devices attached to a mobile communication network according to claim 1, further comprising
generating a list of information of said aggregated devices in said node.

15. The method of managing aggregated devices attached to a mobile communication network according to claim 1, further comprising
providing an interface in said node for accessing said information.

16. The method of managing aggregated devices attached to a mobile communication network according to claim 1, further comprising
providing methods to service and manage the aggregated device through the aggregating device as would it be directly attached to the operator network.

17. A node in a mobile communication network, communicating with at least one aggregated device being attached to said mobile communication network via at least one aggregating device; said aggregating device being attached directly to a radio base station of said mobile communication network; said node comprising:
a network communication unit configured to communicate with said mobile communication network;
a memory configured to store information about aggregated devices attached to said mobile communication network; and
a processor configured to retrieve, using said network communication unit, information regarding at least one aggregated device attached to a respective aggregating device; to store said information in said memory, such that the node comprises information about aggregated devices attached to said mobile communication network; and to provide said information for managing said aggregated devices.

18. The node in a mobile communication network according to claim 17, wherein the node retrieves said information from respective aggregating device.

19. The node in a mobile communication network according to claim 17, further comprising:
a compiler for compiling a list of information of said aggregated devices in said node.

20. The node in a mobile communication network according to claim 17, further comprising:
an interface in said node for accessing said information.

21. The node according to claim 17, wherein the radio access node is a Serving GPRS Support Node.

22. A node according to claim 17, wherein the radio access node is a DCP Node.

23. An aggregating device, configured for attaching an aggregated device to a mobile communication network comprising
a network communication unit configured to communicate with said mobile communication network;
a processor configured to send, using said network communication unit, information regarding at least one aggregated device being attached to the aggregating device; said information uniquely identifying each aggregated device.

24. An aggregated device, configured for being attached to a mobile communication network via a an aggregating device, comprising:
a network communication unit configured to communicate with an aggregating device;
a processor configured to send, using said network communication unit, information uniquely identifying the aggregated device.
